(19) United States
(12) Patent Application Publication
(10) Pub. No.: US 2024/0399917 A1
(43) Pub. Date: Dec. 5, 2024

(54) Charging Control Method and Charging Device for Electric Automobile

(71) Applicant: Autel Digital Power Co., Ltd., Shenzhen (CN)

(72) Inventor: Xiaojie SHEN, Shenzhen (CN)

(73) Assignee: Autel Digital Power Co., Ltd., Shenzhen, GD (CN)

(21) Appl. No.: 18/691,441

(22) PCT Filed: Aug. 3, 2022
(86) PCT No.: PCT/CN2022/109863

§ 371 Date: Mar. 12, 2024

(30) Foreign Application Priority Data
Sep. 14, 2021 (CN) 202111076530.0

(51) Int. Cl. B60L 53/66; B60L 53/16; B60L 53/30; B60L 53/65

(52) U.S. Cl. CPC B60L 53/66; B60L 53/16; B60L 53/305; B60L 53/65; B60L 2250/22

(57) ABSTRACT

A charging control method and a charging device for an electric automobile is are disclosed. The charging device includes a charging pile and a charging pile gun head, and the method firstly establishes a communication connection between the charging pile and the electric automobile within a preset range of the charging pile, then determines whether the charging pile gun head is picked up by a user, and sends an instruction to open the vehicle charging base cover door to the electric automobile when it is determined that the charging pile gun head is picked up by the user to enable the charging pile gun head to be inserted into the charging base of the electric automobile to charge the electric automobile. The charging control method enables a user to charge the electric automobile with simple operation without manually opening or closing the charging base cover door.

The present application claims priority to the Chinese patent application No. 202111076530.0 entitled “charging control method and charging device for electric automobile” filed on Sep. 14, 2021, to the China National Intellectual Property Administration, the entire contents of which are incorporated herein by reference.

### TECHNICAL FIELD

The present application relates to the technical field of charging control of an electric automobile, and particularly to a charging control method and a charging device for an electric automobile.

### BACKGROUND OF THE INVENTION

In the context of the global energy diversification development strategy, after years of technical precipitation, new energy automobiles and associated supporting charging facilities thereof are being accepted by more and more general consumers, and the inventory of electric automobiles and charging piles is also increasing. At the same time, as the new round of global science and technology revolution and industrial transformation has been booming, today's automobile consumers have not been satisfied with the traditional automobile as a transportation tool only, and the consumption form has changed from material type to service type, promoting new energy automobiles to be in the continuous pursuit of intelligent innovation in product form, user experience, etc.

Compared with a traditional automobile which can only gas up at a gas station, a charging pile that can be used at home greatly improves the efficiency of automobile using by consumers. However, regardless of gassing up or charging, the specific operation is relatively complex. The general charging process is (1) lifting a charging gun; (2) opening a charging base cover door of a vehicle; (3) plugging in the charging gun to start charging; (4) unplugging the charging gun when the charging is completed; and (5) closing the charging base cover door of the vehicle. In addition, due to the limitation of battery power and power consumption of current electric automobiles, the usage frequency of the charging pile is usually high, and generally an automobile in use needs to be charged once every 1 to 3 days. Therefore, the current cumbersome charging operation makes the user experience poor. In particular, a switch push button of the charging base cover door of the vehicle is typically located in the cockpit. When the user stops the vehicle first and then wants to charge it, the user needs to operate at the vehicle end and the pile end respectively, or the user cannot charge at all without a key of the vehicle.

### SUMMARY OF THE INVENTION

Embodiments of the present application provide an easy-to-operate charging control method and charging device for an electric automobile.

The object of the embodiments of the present invention is achieved by the following technical scheme.

In order to solve the above technical problems, in the first aspect, an embodiment of the present invention provides a charging control method for an electric automobile. A vehicle charging base cover door is provided on the electric automobile, and the charging control method is applied to a charging device comprising a charging pile and a charging pile gun head, the method comprising:
establishing a communication connection between the charging pile and an electric automobile within a preset range of the charging pile;
determining whether the charging pile gun head is picked up by a user;
and if so, sending an instruction to open the vehicle charging base cover door to the electric automobile so that the charging pile gun head can be inserted into a charging base of the electric automobile to charge the electric automobile.

In some embodiments, a vehicle communication module is provided on the electric automobile, and the establishing a communication connection between the charging pile and an electric automobile within a preset range of the charging pile comprises:
periodically searching for a vehicle communication module within a preset range of the charging pile by broadcasting; and
when an identifiable vehicle communication module is searched, establishing a communication connection between the charging pile and an electric automobile where the identifiable vehicle communication module is located.

In some embodiments, a charging pile gun base is provided on the charging pile, and the determining whether the charging pile gun head is picked up by a user comprises:
detecting whether the charging pile gun head is received in the charging pile gun base by an infrared detection module provided on the charging pile;
and if not, determining that the charging pile gun head is picked up by a user.

In some embodiments, the method further comprises:
after charging is completed, judging whether a user puts the charging pile gun head back on the charging pile gun base;
and if not, prompting the user to home the charging pile gun head.

In some embodiments, after establishing a communication connection between the charging pile and an electric automobile within a preset range of the charging pile, the method further comprises:
reading vehicle information about the electric automobile;
and judging whether the electric automobile is an electric automobile bound to the charging device according to the vehicle information;
and if so, determining that the electric automobile can be charged.

In some embodiments, the method further comprises:
controlling the charging pile to perform a self-test; and
when no abnormality is found in the self-test, determining that the electric automobile can be charged.

In order to solve the above technical problems, according to the second aspect, an embodiment of the present invention provides a charging device comprising:
a charging pile;
a charging pile gun head connected to the charging pile by a transmission cable;
a main controller provided on the charging pile and comprising at least one processor, and a memory communicatively connected to at least one processor, wherein the memory stores an instruction executable by the processor, and the instruction is executed by the processor to enable the processor to execute the charging control method according to the first aspect;
a wireless communication unit connected to the main controller and used for achieving a communication connection with an electric automobile;
and a detection unit provided on the charging pile or the charging pile gun head for detecting whether the charging pile gun head is picked up by a user.

In some embodiments, a vehicle charging base cover door is provided on the electric automobile;
the wireless communication unit comprises:
an automobile communication module connected to a vehicle communication module in the electric automobile for issuing an instruction to open or close the vehicle charging base cover door to the electric automobile.

In some embodiments, the charging pile is provided with a charging pile gun base for accommodating the charging pile gun head;
the detection unit is provided in the charging pile gun base, and the detection unit comprises:
an infrared emission module for emitting infrared light;
and an infrared detection module used for judging whether the charging pile gun head is accommodated in the charging pile gun base according to whether infrared light is received.

In some embodiments, the charging device further comprises:
a display unit connected to the main controller for displaying a state, an operation reminder, and/or an operation progress of the charging device.

Compared to the prior art, the advantageous effects of the present invention are as follows: unlike the prior art, in an embodiment of the present invention, a charging control method and a charging device for an electric automobile are provided. The electric automobile is provided thereon with a vehicle charging base cover door, and the charging control method is applied to the charging device. The charging device comprises a charging pile and a charging pile gun head, and the method firstly establishes a communication connection between the charging pile and the electric automobile within a preset range of the charging pile, then determines whether the charging pile gun head is picked up by a user, and sends an instruction to open the vehicle charging base cover door to the electric automobile when it is determined that the charging pile gun head is picked up by the user. In order to enable the charging pile gun head to be inserted into the charging base of the electric automobile to charge the electric automobile, the charging control method provided by an embodiment of the present invention enables a user to charge the electric automobile with simple operation without manually opening or closing the charging base cover door.

### BRIEF DESCRIPTION OF DRAWINGS

One or more embodiments are exemplified by drawings in the accompanying drawings corresponding to the embodiments. These exemplified descriptions do not constitute a limitation on the embodiments. Elements/modules and steps in the drawings having the same reference number designations are illustrated as similar elements/modules and steps, and unless otherwise particularly stated, the drawings do not constitute a proportional limitation.

FIG. 1 is a schematic view of one of the application environments of a charging control method for an electric automobile provided by an embodiment of the present invention;

FIG. 2 is a schematic flow chart of a charging control method for an electric automobile provided by embodiment 1 of the present invention;

FIG. 3 is a schematic view of a subflow of step S10 in the charging control method shown in FIG. 2;

FIG. 4 is a schematic view of another subflow of step S10 in the charging control method shown in FIG. 2;

FIG. 5 is a schematic view of another subflow of step S10 in the charging control method shown in FIG. 2;

FIG. 6 is a schematic view of another subflow of step S20 in the charging control method shown in FIG. 2;

FIG. 7 is a schematic view of another subflow of step S20 in the charging control method shown in FIG. 2;

FIG. 8 is a schematic view of a structure of a charging device provided by embodiment 2 of the present invention;

FIG. 9 is a schematic view of a structure of another charging device provided by embodiment 2 of the present invention.

### DETAILED DESCRIPTION OF THE INVENTION

Hereinafter, the present invention will be described in detail with reference to specific embodiments. The following embodiments will aid those skilled in the art in further understanding the present invention, but do not limit the invention in any way. It should be noted that several variations and modifications can be further made by a person of ordinary skills in the art without departing from the concept of invention. These are all within the scope of the present invention.

In order to make the object, technical schemes, and advantages of the present application more apparent, a more particular description of the present application will be rendered below with reference to the accompanying drawings and embodiments. It should be understood that the specific embodiments described herein are merely illustrative of the present application and are not intended to be limiting thereof.

It needs to be noted that, if not in conflict, the various features of the embodiments of the invention may be combined with each other and fall within the scope of the present application. In addition, although a functional module division is performed in a schematic view of an apparatus, and a logical order is shown in a flowchart, in some cases, the steps shown or described may be executed in an order other than the module division in the apparatus, or other than the order shown in the flowchart.

Unless defined otherwise, all technical and scientific terms used in the specification have the same meaning as commonly understood by one of ordinary skill in the art to which the present invention belongs. In the description, the terminology used in the description of the present invention is for the purpose of describing specific implementation modes only and is not intended to limit the present invention. As used herein, the term “and/or” includes any and all combinations of one or more of the associated listed items.

Furthermore, the technical features involved in each implementation mode of the present invention described below can be combined with each other as long as they do not conflict with each other.

In order to solve the problem of a relatively complicated user operation in an existing electric automobile charging process, an embodiment of the present invention provides a charging control method and a charging device for an electric automobile. FIG. 1 is a schematic view of one of the application environments of a charging control method for an electric automobile provided by an embodiment of the present invention. The application environment includes therein: a charging pile 101, a charging pile gun head 104, and an electric automobile 106. The charging pile 101 is provided thereon with a charging pile gun base 102, an infrared sensor 103, and a wireless communication unit 105. The electric automobile 106 is provided thereon with a vehicle communication module 107 and a vehicle charging base cover door 108.

The charging pile 101 is an electric energy conversion apparatus used for controlling and adjusting the charging of a power battery of an electric automobile, and is a main component for controlling a charging process. Its input end is connected to the mains supply, and the mains supply is adjusted to a voltage and current usable by the electric automobile 106 and then output via the charging pile gun head 104. The charging pile 101 comprises two types: a direct current charging pile and an alternating current charging pile.

The charging pile gun base 102 is a pre-designed gun base used by a user for inserting/accommodating the charging pile gun head 104 when it is not charging, so that the charging pile gun head 104 can be kept clean and tidy, gun head damage is reduced, and the risk of short circuit is reduced.

The infrared sensor 103 is provided on the charging pile gun base 102 and is composed of an infrared radiation light emitter diode (IRLED) and a photodiode chip, and can detect whether the charging pile gun head 104 is pulled out or inserted into position on the charging pile gun base 102 in a non-contact manner. Specifically, a photodiode chip and an infrared radiation light emitter diode are arranged opposite to each other, and the two are separated when the charging pile gun head 104 is inserted into the charging pile gun base 102. After the charging pile gun head 104 is pulled out, the photodiode chip can detect the infrared light emitted by the infrared radiation light emitter diode, and at this time, the detection circuit in the infrared sensor 103 is conducted to output the result that the charging pile gun head 104 is pulled out. Compared with a mechanical push button, an infrared inserting gun detection has a longer service life, and saves the need to design an active port, thereby improving the overall IP level of the charging pile.

The charging pile gun head 104 is connected to the charging pile 101 via a conveying cable, and is an interface for directly interfacing electric energy and information with an electric automobile 106; when the charging pile 101 and the electric automobile 106 use a standard connection mode C, the charging pile gun head 104 is always connected to the charging pile 101 via a charging cable.

The wireless communication unit 105 is a component embedded in the charging pile 101 and capable of being communicatively connected to the electric automobile 106, including but not limited to Bluetooth, WiFi, etc. which can be specifically provided according to actual needs.

The electric automobile 106 is a motor-driven automobile powered by electric energy, and the power battery system is the main energy storage apparatus mounted on the vehicle. The electric automobile 106 according to an embodiment of the present invention is an electric automobile, with an off-board charging pile, charged by an inserting gun.

The vehicle communication module 107 is a tool that can allow the electric automobile 106 and the charging pile 101 to communicate at the same time. When the charging pile 101 judges that the user needs charging or the charging is completed, the charging pile 101 can issue a command to open or close the vehicle charging base cover door 108 to the electric automobile 106 via the vehicle communication module 107. Preferably, the vehicle communication module 107 may be a vehicle communication interface (VCI) on the electric automobile 106. The information on each module on the electric automobile 106 can be acquired through the interface.

The vehicle charging base cover door 108 is a structure for protecting the intact use and tidiness of the charging connector of the electric automobile 106, and at the same time, can prevent accidental leakage of high-voltage parts on the vehicle, and is thus opened only when charging is required. Generally, the Alternating current charging port and the Direct current charging port of the electric automobile 106 use the same cover door. Some vehicles are designed in front of the vehicle and some are designed behind the vehicle.

Specifically, an embodiment of the present invention will be further described with reference to the following drawings.

### Embodiment 1

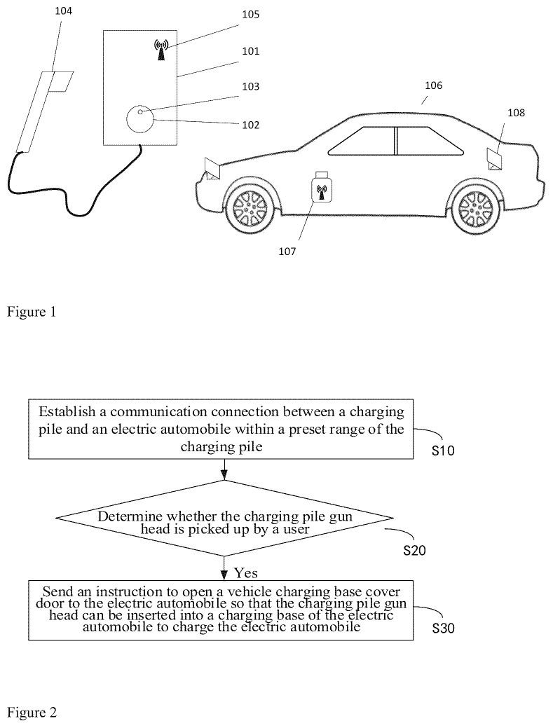

An embodiment of the present invention provides a charging control method for an electric automobile. A vehicle charging base cover door is provided on the electric automobile, and the charging control method is applied to a charging device. The charging device comprises a charging pile and a charging pile gun head, and the charging device can be a pile 101 and a charging pile gun head 104 as shown in the above-mentioned application scenario and FIG. 1, and the electric automobile can also be an electric automobile 106 as shown in the above-mentioned application scenario and FIG. 1. Specifically, according to different application scenarios, it can be in different forms and does not need to be bound by the limitations of the embodiments of the present invention. Please refer to FIG. 2. It shows a schematic flow chart of a charging control method for an electric automobile provided by an embodiment of the present invention. The method includes but is not limited to the following steps:

step S10: establishing a communication connection between the charging pile and an electric automobile within a preset range of the charging pile.

In an embodiment of the present invention, firstly, a communication connection between the charging pile and an electric automobile needing to be charged needs to be established so as to realize intelligent control. Since an electric automobile usually stops near a charging pile when needing to be charged to facilitate charging, it is possible to determine whether an electric automobile exists around and establish communication by detecting whether an electric automobile exists within the preset range of the charging pile. The preset range can be set according to the current parking scene. For example, in the case of a relatively open parking scene, the range can be set to be relatively large, and otherwise set to be relatively small in the case of a relatively narrow place such as an underground parking garage, for example, a range within five meters of the radius of the charging pipe, so as to avoid the connection with other surrounding electric automobiles.

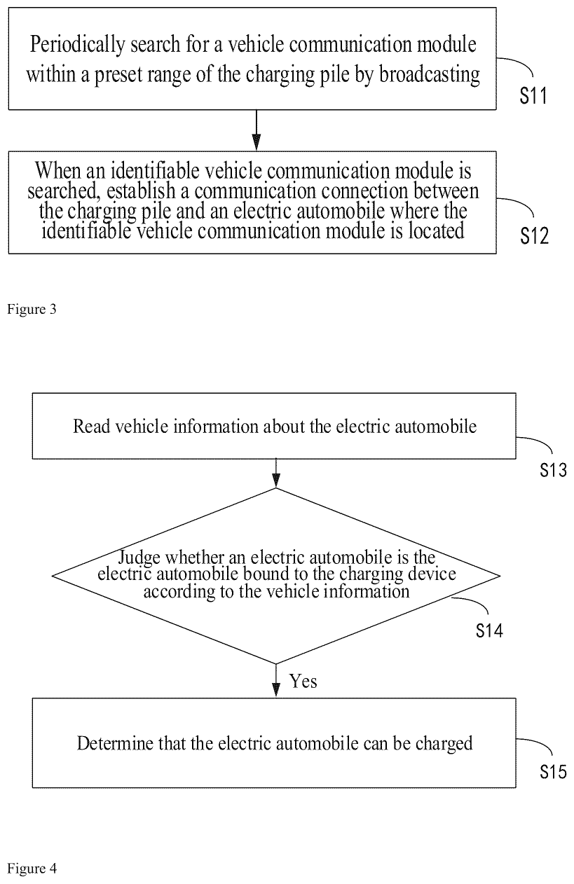

Specifically, a vehicle communication module is provided on the electric automobile. Please refer to FIG. 3 together, which shows a subflow of step S10, wherein the establishing a communication connection between the charging pile and an electric automobile within a preset range of the charging pile comprises:

step S11: periodically searching for a vehicle communication module within a preset range of the charging pile by broadcasting; and

step S12: when an identifiable vehicle communication module is searched, establishing a communication connection between the charging pile and an electric automobile where the identifiable vehicle communication module is located.

In an embodiment of the present invention, the charging device may be configured to periodically search for a vehicle communication module within a preset range of a charging pile by using a broadcast mode, sequentially inquire whether the vehicle communication module within the preset range requires a charging service by using a Polling mode, and establish a communication connection when an electric automobile requiring charging is searched. Furthermore, the periodicity and the preset range can be set according to a user's usage scenario. For example, in the case where a user generally drives a vehicle out in the morning and goes back home from work at night, it can be set as such that a function of periodically scanning a vehicle communication module in a parking space range is started at the off-duty time; the vehicle communication module in the preset range of the charging pile can be searched once every time period, for example, every second, so that when the electric automobile appears in the vicinity of the charging device, a connection can be quickly and automatically established so as to make the user have a feelingless experience; specifically, the setting of the period and the preset range can be adjusted according to actual needs without being restricted to limitations of the embodiments of the present invention.

Further, refer to FIG. 4 together, which shows another subflow of step S10. The method further comprises:

step S13: reading vehicle information about the electric automobile:

step S14: judging whether the electric automobile is an electric automobile bound to the charging device according to the vehicle information; and if so, jumping to step S15; and

step S15: determining that the electric automobile can be charged.

In everyday life, since currently, residents are generally able to own a dedicated parking space, the charging pile may generally also be private or appropriative in this community or area. In order to effectively manage the user, in an embodiment of the present invention, it is further possible to determine, after establishing the communication, whether it is an electric automobile bound to the charging device according to the read vehicle information. Specifically, a vehicle identification number/vehicle frame number (VIN) of the electric automobile can be acquired. The number is a number unique to each electric automobile consisting of 17 letters or numbers, stored in the electric automobile, and can be called and sent to the charging device for identification.

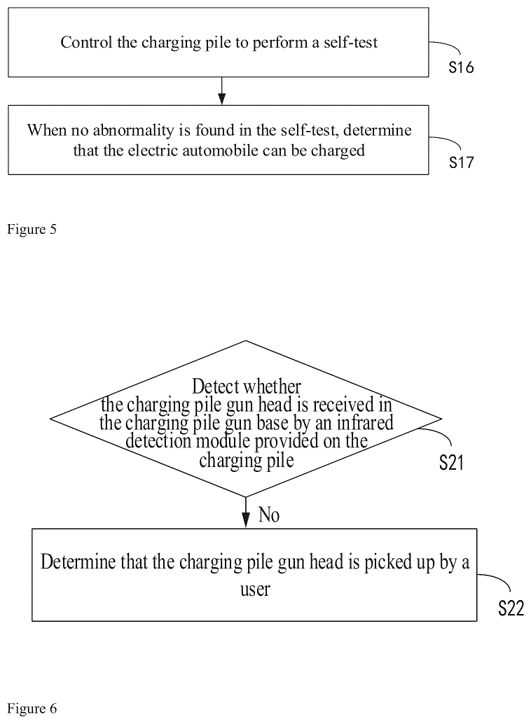

Further, refer to FIG. 5 together, which shows another subflow of step S10. The method further comprises:

step S16: controlling the charging pile to perform a self-test; and

step S17: when no abnormality is found in the self-test, determining that the electric automobile can be charged.

In an embodiment of the present invention, further, in order to avoid a case where the charging pile is connected to the electric automobile to destroy the electric automobile in an abnormal situation such as an overcurrent or an overvoltage, after it is determined that the user has an intention of charging, it is also necessary to control the charging pile to perform a self-test, prompt the user of a charging failure if there is an abnormality, and turn off the output, not allowing the subsequent charging operation.

Step S20: determine whether the charging pile gun head is picked up by a user; if so, jump to step S30.

In an embodiment of the present invention, after it is determined that there is an electric automobile in the surroundings that needs to be charged, and a connection is established with the electric automobile, it is judged whether the charging pile gun head is picked up by a user. Specifically, whether the charging pile gun head is picked up by a user may be determined by detecting whether the charging pile gun head is clear of a charging pile gun base through an infrared sensor as described in the above application scenario. After it is determined that it is picked up by the user, it can be determined that the user is ready to insert the charging pile gun head into the charging base of the electric automobile. Jump to step S30 to charge the electric automobile when it is detected that the charging pile gun head is inserted into the charging base.

Specifically, a charging pile gun base is provided on the charging pile. Please refer to FIG. 6 together, which shows a subflow of step S20. The determining whether the charging pile gun head is picked up by a user comprises:

step S21: detecting whether the charging pile gun head is received in the charging pile gun base by an infrared detection module provided on the charging pile; and if not, jumping to step S22; and

step S22: determining that the charging pile gun head is picked up by the user.

In an embodiment of the present invention, it is preferable to determine whether the charging pile gun head is picked up by a user by detecting whether the charging pile gun head is received in the charging pile gun base by providing an infrared detection module on the charging pile gun base.

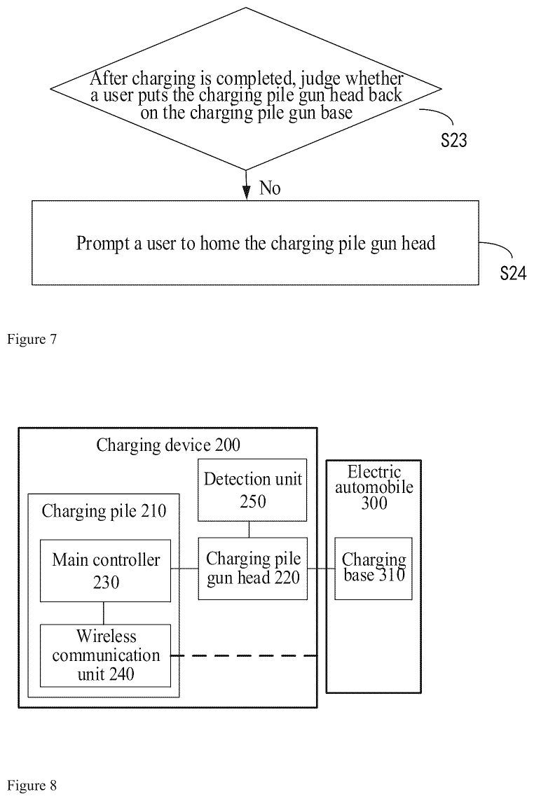

Further, refer to FIG. 7 together, which shows another subflow of step S20. The method further comprises:

step S23: after the charging is completed, judging whether a user puts the charging pile gun head back on the charging pile gun base; and if not, jumping to step S24; and

step S24: prompting a user to home the charging pile gun head.

In an embodiment of the present invention, after charging the electric automobile is finished, further, in order to avoid a safety accident occurring when the charging pile gun head is always connected to the electric automobile when the electric automobile starts up, it is also necessary to detect whether the user puts the charging pile gun head back on the charging pile gun base by means of the above-mentioned infrared detection module, and if not, then a prompt is sent out to prompt the user to home the charging pile gun head. Preferably, in order for the user to notice the prompt, the user may be alerted by means of a voice broadcast, in combination with a text display, and/or by means of a push of relevant application content on the mobile device.

Step S30: send an instruction to open the vehicle charging base cover door to the electric automobile so that the charging pile gun head can be inserted into a charging base of the electric automobile to charge the electric automobile.

The instruction to open a vehicle charging base cover door of the electric automobile is sent after it is determined that the user picks up the charging pile gun head and needs to perform charging, so that the charging base of the electric automobile can be exposed to insert into the charging pile gun head, and after the user inserts the charging pig gun head into the charging base of the electric automobile, the electric automobile can be charged.

The charging control method for charging the electric automobile provided by the embodiments of the present invention can effectively simplify the charging process, and the user does not need to operate back and forth between the electric automobile and the charging pile in order to charge, so as to solve the problem that the user needs to bend to open the charging base cover door in the cockpit when the electric automobile needs to be charged, and the user has a poor experience, and also solve the problem that the charging cannot be performed when the vehicle key is not provided, and solve the problem that it is inconvenient to open the charging base cover door of the vehicle by lifting the charging gun by two hands; in addition, the problem that an insert-and-use private charging pile cannot lock a dedicated user is also solved by acquiring vehicle information for identification; by providing a charging pile gun base and detecting whether a gun head is in the charging pile gun base and outputting a prompt, the problem such as improperly accommodating a charging line after the charging is completed is solved.

### Embodiment 2

A charging device according to an embodiment of the present invention is disclosed. Refer to FIG. 8, a structure of a charging device provided by an embodiment of the invention is shown. The charging device includes: a charging pile 210, a charging pile gun head 220, a main controller 230, a wireless communication unit 240, and a detection unit 250.

The charging pile 210 may be a charging pile 101 as described in the above application scenario and shown in FIG. 1, which is capable of converting the mains supply into electric energy that can be used by the electric automobile 300. Further, the charging pile 210 can also collect and analyze real-time parameters of the voltage, current, temperature, etc. to provide effective data for the calculation of electric quantity, temperature control, and circuit protection. Furthermore, the charging pile 210 also has a protection function. After the real-time parameters such as the voltage, current, and temperature are collected, real-time protection can be provided in the case of over-voltage, under-voltage, over-current, and like situations so as to avoid damages to the charging pile 210 itself and the electric automobile 300.

The charging pile gun head 220 is connected to the charging pile 210 via a transmission cable; likewise, the charging pile gun head 220 can be the charging pile gun head 104 as shown in the above-mentioned application scenario and FIG. 1, for being inserted into a charging base 310 of the electric automobile 300 to achieve charging.

The wireless communication unit 240, which is connected to the main controller 230, is used for achieving a communication connection with the electric automobile 300.

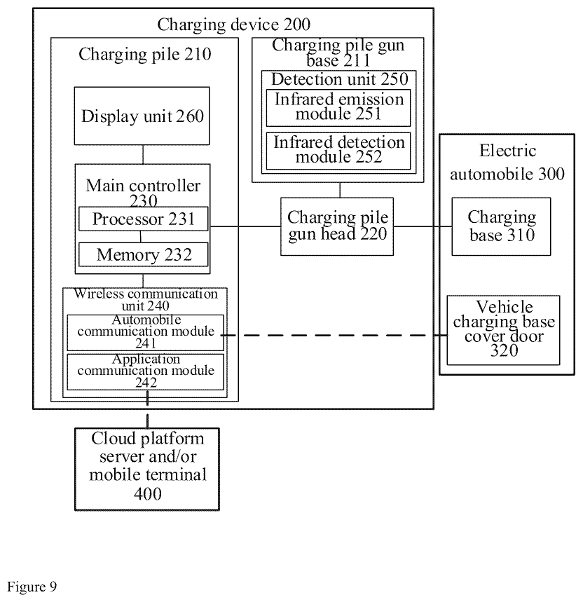

Specifically, refer to FIG. 9, which shows the structure of another charging device provided by an embodiment of the present invention. The electric automobile 300 is provided with a vehicle charging base cover door 320, and the wireless communication unit 240 includes: a vehicle communication module 241 connected to a vehicle communication module 330 in the electric automobile 300 for issuing an instruction to open or close the vehicle charging base cover door 320 to the electric automobile 300. The vehicle communication module 241 is a module dedicated to data interaction with the electric automobile 300 through wireless communication. When there is no abnormality, the charging pile 210 can send an instruction to open and close the vehicle charging base cover door 320 to the electric automobile 300 through the module.

Further, the wireless communication unit 240 may further include: an application communication module 242, which can be an apparatus for realizing data communication with a cloud platform server and/or a mobile terminal 400, etc. by means of communication modes such as WiFi, Bluetooth, 4G, CAN, serial port, Ethernet, etc. and the mobile terminal 400 can be a smart phone of a user.

The detection unit 250, which is provided on the charging pile 210 or the charging pile gun head 220, is used for detecting whether the charging pile gun head 220 is picked up by a user.

Specifically, with continued reference to FIG. 9, the charging pile 210 is provided with a charging pile gun base 211 for accommodating the charging pile gun head 220, the detection unit 250 is provided in the charging pile gun base, and the detection unit 250 comprises: an infrared emission module 251 for emitting infrared light; and an infrared detection module 252 for judging whether the charging pile gun head 220 is accommodated in the charging pile gun base 211 according to whether an infrared light is received.

Further, with continued reference to FIG. 9, the charging device 200 further includes: a display unit 260 connected to the main controller 230 and used for displaying the state, operation reminders, and/or operation progress of the charging device 200. Specifically, the display unit 260 is used for displaying charging-related information so as to facilitate indicating the state of a charging process, or guiding a user to operate correctly, such as a vehicle charging base cover door open and close state, a charging gun inserted into a vehicle charging port state, and a charging gun inserted into a pile and a charging gun returning port state, which, specifically, can be set according to actual needs.

The main controller 230 is provided on the charging pile 210 and includes at least one processor 231, and a memory 232 communicatively connected to at least one processor 231. The memory 232 stores an instruction executable by a processor, the instruction being executed by the processor 231 to enable the processor 231 to execute the charging control method according to the above-described embodiments. The processor 231 and the memory 232 may be connected by a bus or other ways, as exemplified by a bus connection in FIG. 9. The main controller 230, as a component of the core collection, analysis, calculation, control, communication, and other functions of the charging device 200, can realize the overall control of charging.

The memory 232 is a non-volatile computer-readable storage medium that can be used to store a non-volatile software program, a nonvolatile computer-executable program, and a module, such as a program instruction/module corresponding to the charging control method in an embodiment of the present application. The processor 231 executes various functional applications of a server and data processing by running non-volatile software programs, instructions, and modules stored in the memory 232, i.e. it achieves the charging control method of the above-described method embodiment. The memory 232 is also used for storing user information and vehicle information so as to realize the automatic identification function of vehicles of different vehicle models, and the charging pile respectively controls different vehicles through respective communication protocols.

The memory 232 can include a program storage area and a data storage area. The program storage area can store an operating system and an application program required by at least one function; the storage data area may store data and the like created according to the use of the charging control apparatus. In addition, the memory 232 may include high speed random access memory and may also include non-volatile memory, such as at least one magnetic disk storage device, flash memory device, or other non-volatile solid state storage devices. In some embodiments, the memory 232 optionally includes a memory remotely provided with respect to the processor 231. These remote memories may be connected to a charging control apparatus via a network. Examples of such networks include, but are not limited to, the Internet, Intranets, local area networks, mobile communication networks, and combinations thereof.

One or more modules are stored in the memory 232 and, when executed by the one or more processors 231, execute the charging control method in any of the method embodiments described above, e.g. executing the method steps of FIGS. 2-7 described above, and achieving the functions of each module and each unit of FIG. 1 and/or FIGS. 8-9.

The above-mentioned product can execute the method provided by the embodiments of the present application, and has corresponding functional modules and beneficial effects for executing the method. Technical details not described in detail in the embodiment can be referred to the method provided in the embodiments of the present application.

An embodiment of the present application also provides a non-volatile computer-readable storage medium storing a computer-executable instruction that is executed by one or more processors, e.g. executing the method steps of FIGS. 2-7 described above and achieving the functions of each module and each unit of FIG. 1 and/or FIGS. 8-9.

An embodiment of the present application also provides a computer program product comprising a computer program stored on a non-volatile computer-readable storage medium. The computer program includes a program instruction which, when executed by a computer, causes the computer to execute the charging control method in any of the method embodiments described above, e.g. executing the method steps of FIGS. 2-7 described above and achieving the functions of each module and each unit of FIG. 1 and/or FIGS. 8-9.

In an embodiment of the present invention, a charging control method and a charging device for an electric automobile are provided. The electric automobile is provided thereon with a vehicle charging base cover door, and the charging control method is applied to the charging device. The charging device comprises a charging pile and a charging pile gun head, and the method firstly establishes a communication connection between the charging pile and the electric automobile within a preset range of the charging pile, then determines whether the charging pile gun head is picked up by a user, and sends an instruction to open the vehicle charging base cover door to the electric automobile when it is determined that the charging pile gun head is picked up by the user. In order to enable the charging pile gun head to be inserted into the charging base of the electric automobile to charge the electric automobile, the charging control method provided by an embodiment of the present invention enables a user to charge the electric automobile with simple operation without manually opening or closing the charging base cover door.

It needs to be noted that the above-described apparatus embodiments are merely illustrative. The units described as separate components may or may not be physically separated, and the components displayed as units may or may not be physical units, that is, they may be located in one place, or they may be distributed on multiple network units. Some or all of the modules can be selected according to actual needs to achieve the purpose of the scheme of the embodiment.

From the above description of the implementation modes, it will be clear to a person of ordinary skills in the art that the implementation modes can be implemented by means of software plus a general purpose hardware platform, and of course, also by means of hardware. A person of ordinary skills in the art can understand that the implementation of all or part of the processes in the method of the above embodiments can be completed by instructing the relevant hardware through a computer program. The program can be stored in a computer-readable storage medium. When the program is executed, it can include the processes in the embodiments of the above methods. The storage medium may be a magnetic disk, an optical disk, a Read-Only Memory (ROM) or a Random Access Memory (RAM), etc.

Finally, it should be noted that: the above embodiments are merely illustrative of the technical schemes of the present invention, rather than limiting it; combinations of technical features in the above embodiments or in different embodiments are also possible under the idea of the present invention, and the steps can be implemented in any order; there are many other variations of the different aspects of the present invention as described above, which are not provided in detail for the sake of brevity; although the present invention has been described in detail with reference to the foregoing embodiments, those of ordinary skills in the art will appreciate that the technical schemes disclosed in the above-mentioned embodiments can still be modified, or some of the technical features thereof can be replaced by equivalents; such modifications or replacements do not depart the essence of the corresponding technical scheme from the scope of the technical schemes of embodiments of the present invention.

1. A charging control method for an electric automobile, wherein a vehicle charging base cover door is provided on the electric automobile, and the charging control method is applied to a charging device comprising a charging pile and a charging pile gun head, the method comprising:
establishing a communication connection between the charging pile and an electric automobile within a preset range of the charging pile;
determining whether the charging pile gun head is picked up by a user;
and if so, sending an instruction to open the vehicle charging base cover door to the electric automobile so that the charging pile gun head can be inserted into a charging base of the electric automobile to charge the electric automobile.

2. The charging control method according to claim 1, wherein a vehicle communication module is provided on the electric automobile, and the establishing communication connection between the charging pile and an electric automobile within a preset range of the charging pile comprises:
periodically searching for a vehicle communication module within a preset range of the charging pile by broadcasting; and
when an identifiable vehicle communication module is searched, establishing a communication connection between the charging pile and an electric automobile where the identifiable vehicle communication module is located.

3. The charging control method according to claim 1, wherein a charging pile gun base is provided on the charging pile, and the determining whether the charging pile gun head is picked up by a user comprises:
detecting whether the charging pile gun head is received in the charging pile gun base by an infrared detection module provided on the charging pile;
and if not, determining that the charging pile gun head is picked up by a user.

4. The charging control method according to claim 3, wherein the method further comprises:
after charging is completed, judging whether a user puts the charging pile gun head back on the charging pile gun base;
and if not, prompting the user to home the charging pile gun head.

5. The charging control method according to claim 1, wherein after establishing a communication connection between the charging pile and an electric automobile within a preset range of the charging pile, the method further comprises:
reading vehicle information about the electric automobile;
and judging whether the electric automobile is an electric automobile bound to the charging device according to the vehicle information;
and if so, determining that the electric automobile can be charged.

6. The charging control method according to claim 5, wherein the method further comprises:
controlling the charging pile to perform a self-test; and
when no abnormality is found in the self-test, determining that the electric automobile can be charged.

7. A charging device, comprising:
a charging pile;
a charging pile gun head connected to the charging pile by a transmission cable;
a main controller provided on the charging pile and comprising at least one processor, and a memory communicatively connected to the at least one processor, wherein the memory stores an instruction executable by the processor, and the instruction is executed by the processor to enable the processor to execute the charging control method comprising steps of:
establishing a communication connection between the charging pile and an electric automobile within a preset range of the charging pile;
determining whether the charging pile gun head is picked up by a user;
and if so, sending an instruction to open the vehicle charging base cover door to the electric automobile so that the charging pile gun head can be inserted into a charging base of the electric automobile to charge the electric automobile;
a wireless communication unit connected to the main controller and used for achieving a communication connection with an electric automobile; and
a detection unit provided on the charging pile or the charging pile gun head for detecting whether the charging pile gun head is picked up by a user.

8. The charging device according to claim 7, wherein
a vehicle charging base cover door is provided on the electric automobile;
the wireless communication unit comprises:
an automobile communication module connected to a vehicle communication module in the electric automobile for issuing an instruction to open or close the vehicle charging base cover door to the electric automobile.

9. The charging device according to claim 7, wherein
the charging pile is provided with a charging pile gun base for accommodating the charging pile gun head;
the detection unit is provided in the charging pile gun base, and the detection unit comprises:
an infrared emission module for emitting infrared light;
and an infrared detection module used for judging whether the charging pile gun head is accommodated in the charging pile gun base according to whether infrared light is received.

10. The charging device according to claim 7, wherein the charging device further comprises:
a display unit connected to the main controller for displaying a state, an operation reminder, and/or an operation progress of the charging device.
